(19) United States
(12) Patent Application Publication
(10) Pub. No.: US 2017/0142047 A1
(43) Pub. Date: May 18, 2017

(54) SYSTEMS AND METHODS FOR PROVIDING MULTIMEDIA REPLAY FEEDS

(71) Applicant: Facebook, Inc., Menlo Park, CA (US)

(72) Inventor: John Taskin Mendiola, Fair Oaks, CA (US)

(21) Appl. No.: 14/945,045

(22) Filed: Nov. 18, 2015

(51) Int. Cl. H04L 12/58

(52) U.S. Cl. CPC H04L 51/12; H04L 51/32; H04L 51/10

(57) ABSTRACT

Systems, methods, and non-transitory computer-readable media can receive a plurality of content posts posted to a social networking system. The plurality of content posts are filtered based on filtering criteria to determine one or more filtered content posts. Multimedia content items from the one or more filtered content posts are presented in succession as a multimedia feed, wherein succession of the multimedia content items occurs without user intervention.

### FIELD OF THE INVENTION

The present technology relates to the field of social networks. More particularly, the present technology relates to providing multimedia replay feeds.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

User experience associated with a social networking system can be enhanced as the social networking system becomes more knowledgeable about the users that it serves. When knowledge of a user is gained, content, advertising, and other services can be optimized for presentation to the user. Such potentially helpful knowledge about the user can include information about the user as an individual as well as the user's activity on the social network. Knowledge about the user can be utilized to provide features that increase user interest in and engagement with the social networking system.

### SUMMARY

Various embodiments of the present disclosure can include systems, methods, and non-transitory computer readable media configured to receive a plurality of content posts posted to a social networking system. The plurality of content posts are filtered based on filtering criteria to determine one or more filtered content posts. Multimedia content items from the one or more filtered content posts are presented in succession as a multimedia feed, wherein succession of the multimedia content items occurs without user intervention.

In an embodiment, the one or more filtered content posts are ranked based on ranking criteria.

In an embodiment, the multimedia content items from the one or more filtered content posts are presented in succession in an order based on the ranking the one or more filtered content posts.

In an embodiment, the one or more filtered content posts are ranked chronologically.

In an embodiment, the multimedia content items from the one or more filtered content posts are presented in succession without any text content items.

In an embodiment, the filtering the plurality of content posts based on filtering criteria comprises filtering the plurality of content posts to remove content posts that do not contain multimedia content items.

In an embodiment, the filtering the plurality of content posts based on filtering criteria comprises filtering the plurality of content posts to remove content posts that have previously been viewed by a user.

In an embodiment, the filtering the plurality of content posts based on filtering criteria comprises filtering the plurality of content posts to remove content posts that do not satisfy a time threshold.

In an embodiment, the time threshold is based on a last login time for a user.

In an embodiment, the filtering the plurality of content posts based on filtering criteria comprises receiving active filtering criteria from a user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a multimedia replay feed module, according to an embodiment of the present disclosure.

FIG. 2 illustrates an example filtering module, according to an embodiment of the present disclosure.

FIG. 3 illustrates an example interface module, according to an embodiment of the present disclosure.

FIG. 4 illustrates an example scenario including an example multimedia replay feed interface, according to an embodiment of the present disclosure.

FIG. 5 illustrates an example method for providing multimedia replay feeds, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Social Network Multimedia Replay Feeds

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system.

User experience associated with a social networking system can be enhanced as the social networking system becomes more knowledgeable about the users that it serves. Knowledge about users and the way they interact on a social networking system allows the social networking system to provide features and products that are of interest to users and increase user engagement with the social networking system. As user interest in and engagement with a social networking system increases, the increased interactions among users help to realize the goals and full potential of the social networking system.

It continues to be an important interest for a social networking system rooted in computer technology to maximize user engagement with the social networking system. However, it can be difficult to analyze available information to effectively provide products and features that will be of interest to users. This is particularly true given that many users become overwhelmed by the amount of new content posted on a social networking system. For example, many users experience what is referred to as “swipe fatigue” or “scroll fatigue” when they have to continuously swipe or scroll through large amounts of new content. Such fatigue may lead users to browse for a short period of time, until they grow weary of the continuous swiping or scrolling and stop looking at new content. When users stop browsing through content even when new, unseen content is available, users may miss out on content that may be of interest to them.

Therefore, an improved approach can be beneficial for overcoming these and other disadvantages associated with conventional approaches. Based on computer technology, the disclosed technology can provide a multimedia replay feed. The multimedia replay feed can comprise an automatic presentation of multimedia content items that have been posted on the social networking system that the user has not previously seen. For example, the multimedia replay feed can include multimedia content that has been posted since the user's last login. In certain embodiments, multimedia content items may be presented without any accompanying text, such that the user is only presented with multimedia content such as images and videos. A user can adjust the playback properties of the multimedia replay feed, for example, by speeding it up, slowing it down, choosing to exclude certain posts from future multimedia replay feeds, and the like. If a user sees a multimedia content item that is of particular interest, the user can temporarily exit or pause the multimedia replay feed to view and interact with the multimedia content item. When the user has completed interacting with the multimedia content item, the multimedia replay feed can resume.

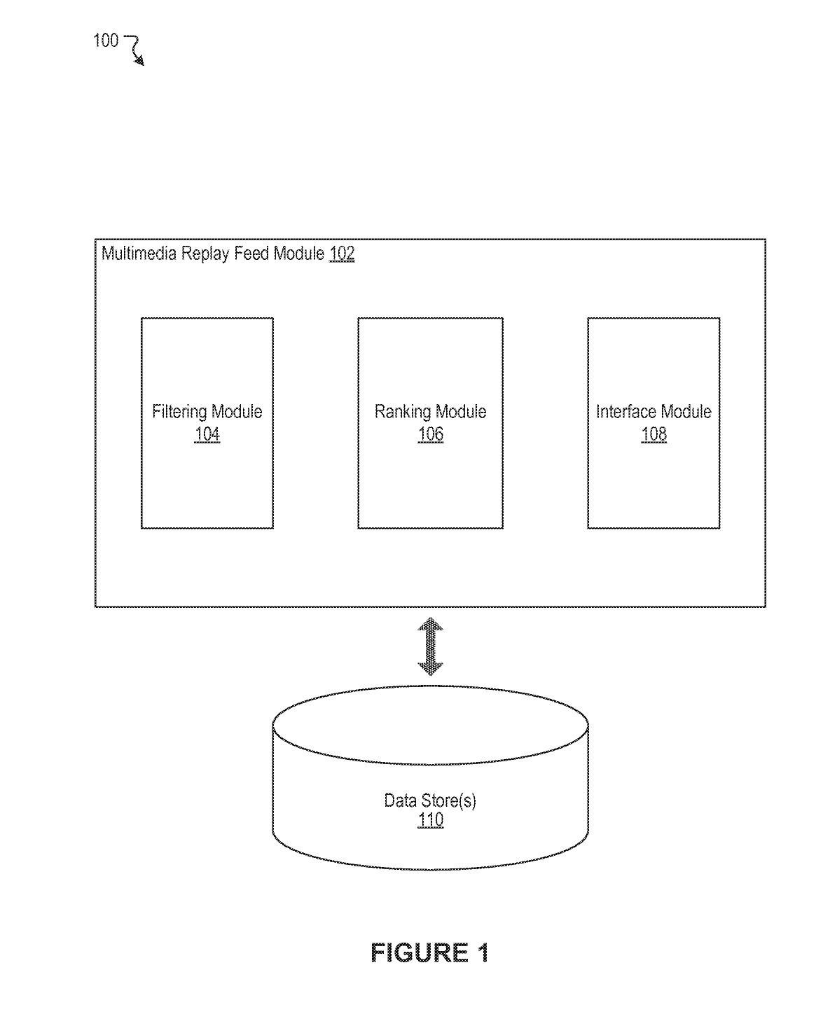

FIG. 1 illustrates an example system 100 including an example multimedia replay feed module 102 configured to provide a multimedia replay feed on a social networking system, according to an embodiment of the present disclosure. The multimedia replay feed module 102 can be configured to analyze a plurality of content posts on a social networking system for multimedia content items. Content posts can include content posted by users of a social networking system, and can also include advertisements posted by advertisers on the social networking system. It should be understood, where modules or components are described herein as interacting in a particular way with a content post, those modules or components can also be configured to interact with individual multimedia or non-multimedia content items that are the components of a content post.

Multimedia content items that have not been previously seen by or presented to a user can be presented to the user in an automatic replay feed, i.e., a multimedia replay feed. The multimedia replay feed may remove any text content items from the content posts such that only multimedia content items are presented. For example, consider an example scenario in which a user's connections on a social networking system have posted three new content posts since the user's last login onto the social networking system: a photo album containing twenty-five photos, a video, and a text status message. The multimedia replay feed module 102 can be configured to determine the multimedia content items contained in these recent content posts. In this example scenario, the multimedia replay feed can identify the twenty-five photos and the video, and recognize that the text status message does not contain any multimedia content items. The multimedia replay feed module 102 can also be configured to take the multimedia content items (i.e., the twenty-five photos and the video in this example) and present them in a multimedia replay feed that presents each of the multimedia content items in automatic succession for viewing by the user. Advancement of the multimedia replay feed from one multimedia content item to the next can occur without user intervention or input. For example, the user can initiate the multimedia replay feed by selecting a “Reply” button, and the multimedia replay feed can automatically play each of the twenty-five photos and the video in succession for a predetermined period of time without further user intervention, e.g., play each photo for one second before automatically going to the next photo, and play a three-second clip of the video before automatically moving to the next multimedia content item. The multimedia replay feed may remove any text content items associated with the multimedia content items, so that only multimedia content items are presented to the user. For example, if one or more of the photos of the video have an accompanying textual caption or description, the multimedia replay feed can be configured such that the textual caption and/or description is not presented in the multimedia replay feed. The multimedia replay feed module 102 can include a user interface to allow the user to interact with the multimedia replay feed in a variety of ways.

As shown in the example of FIG. 1, the multimedia replay feed module 102 can include a filtering module 104 a ranking module 106, and an interface module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The filtering module 104 can be configured to filter content posts on a social networking system based on various filtering criteria. Content posts on the social networking system can be filtered to determine which content posts to utilize in a multimedia replay feed. For example, the filtering module 104 can be configured to filter out any content posts that do not contain any multimedia content items, such as text status messages or notes. In certain embodiments, the filtering module 104 can also filter content posts that a user has previously seen. The filtering module 104 can also be configured to filter out content posts that were posted earlier than a time threshold. For example, the filtering module 104 can filter out any content posts that were posted prior to the time of the user's last login onto a social networking system. In other words, the filtering module 104 can be configured to include only “new” content posts that the user has not seen since his or her last login. In other embodiments, the time threshold may be a predefined period of time, such that the filtering module 104 filters out all content posts that are, for example, more than one day or one week old. The filtering module 104 can also be configured to filter out content posts based on the content of the posts. For example, the filtering module 104 can include an “active filter” that removes any content posts that involve particular people or things. The filtering module 104 is discussed in greater detail herein.

The ranking module 106 can be configured to rank content posts and/or multimedia content items from content posts based on various ranking criteria. In certain embodiments, the ranking module 106 can be configured to receive one or more filtered content posts from the filtering module 106 and to rank either the content posts and/or multimedia content items from the content posts. Multimedia content items can then be presented in a multimedia replay feed. For example, multimedia content items can be ranked chronologically based on the time that the multimedia content items were posted to a social networking system. The multimedia replay feed can present multimedia content items in chronological order such that a user is presented with multimedia content items in the order that they were posted to the social networking system. Conversely, multimedia content items can be presented in reverse-chronological order, i.e., from newest to oldest. In other embodiments, multimedia content items can be ranked based on content information and/or poster information. For example, multimedia content items can be ranked based, at least in part, on a “friendship coefficient” which determines the affinity between a viewing user and the poster of a multimedia content item. The friendship coefficient may take into account the quantity and quality of interactions between the two users on the social networking system as well as friendship designations selected by the users (e.g., designating a particular user as a “close friend”).

The interface module 108 can be configured to present a multimedia replay feed to a user and allow the user to interact with the multimedia replay feed. In certain embodiments, the interface module 108 can be configured to allow a user to adjust the playback properties of the multimedia replay feed. For example, the user can be presented with a control panel that allows a user to speed up or slow down the multimedia replay feed, or to skip ahead, or to rewind, or to pause the multimedia replay feed. In addition to or in place of the control panel, the user can adjust the playback properties of the multimedia replay feed using particular gestures, such as swipes or taps on a touchscreen. The interface module 108 can also be configured to allow a user to select various user preferences as discussed throughout the present disclosure. For example, the interface module 108 can provide an interface for a user to select various persons or things that the user wishes to filter out via the “active filtering” function of the filtering module 102. The interface module 108 can also be configured to allow a user to interact with multimedia content items in the multimedia replay feed. For example, users can “like” multimedia content items, or can pause the multimedia replay feed to comment on a multimedia content item. The interface module 108 is discussed in greater detail herein.

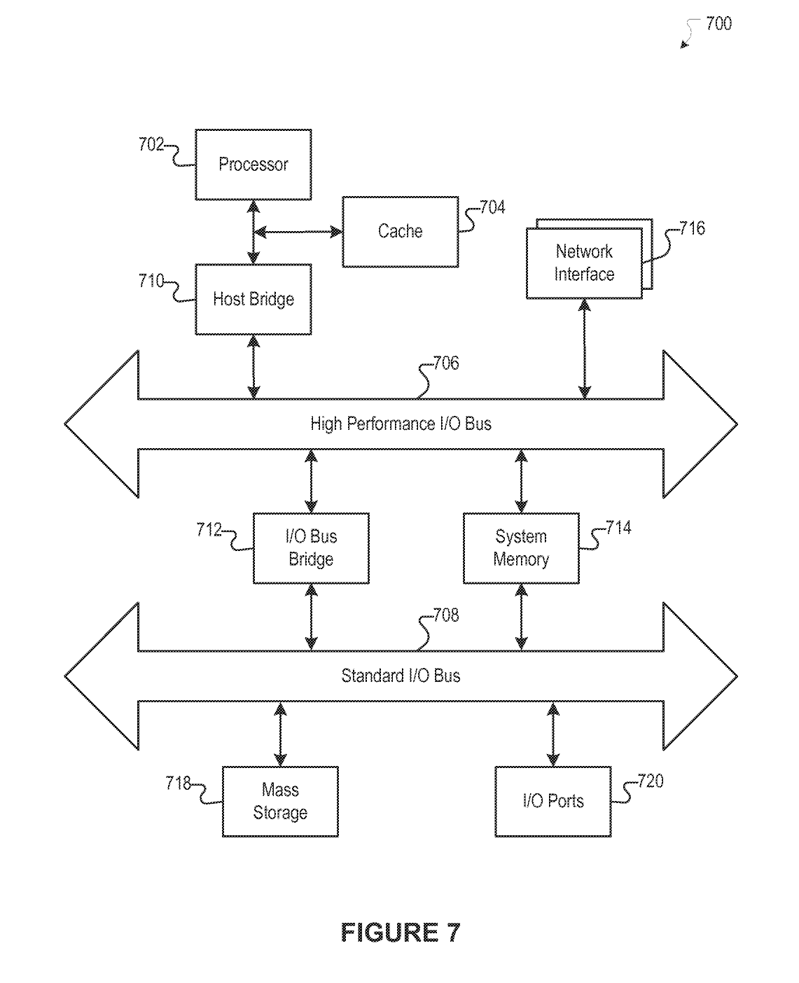

The multimedia replay feed module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the multimedia replay feed module 102 can be implemented, in part or in whole, as software running on one or more computing devices or systems, such as on a server computing system or a user (or client) computing system. For example, the multimedia replay feed module 102 or at least a portion thereof can be implemented as or within an application (e.g., app), a program, or an applet, etc., running on a user computing device or a client computing system, such as the user device 710 of FIG. 7. In another example, the multimedia replay feed module 102 or at least a portion thereof can be implemented using one or more computing devices or systems that include one or more servers, such as network servers or cloud servers. In some instances, the multimedia replay feed module 102 can, in part or in whole, be implemented within or configured to operate in conjunction with a social networking system (or service), such as the social networking system 730 of FIG. 7. It should be understood that there can be many variations or other possibilities.

The multimedia replay feed module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the multimedia replay feed module 102. For instance, the data store 110 can store filtering criteria, ranking criteria, user preference information, and any other information that may be used to carry out the present technology disclosed herein. It is contemplated that there can be many variations or other possibilities.

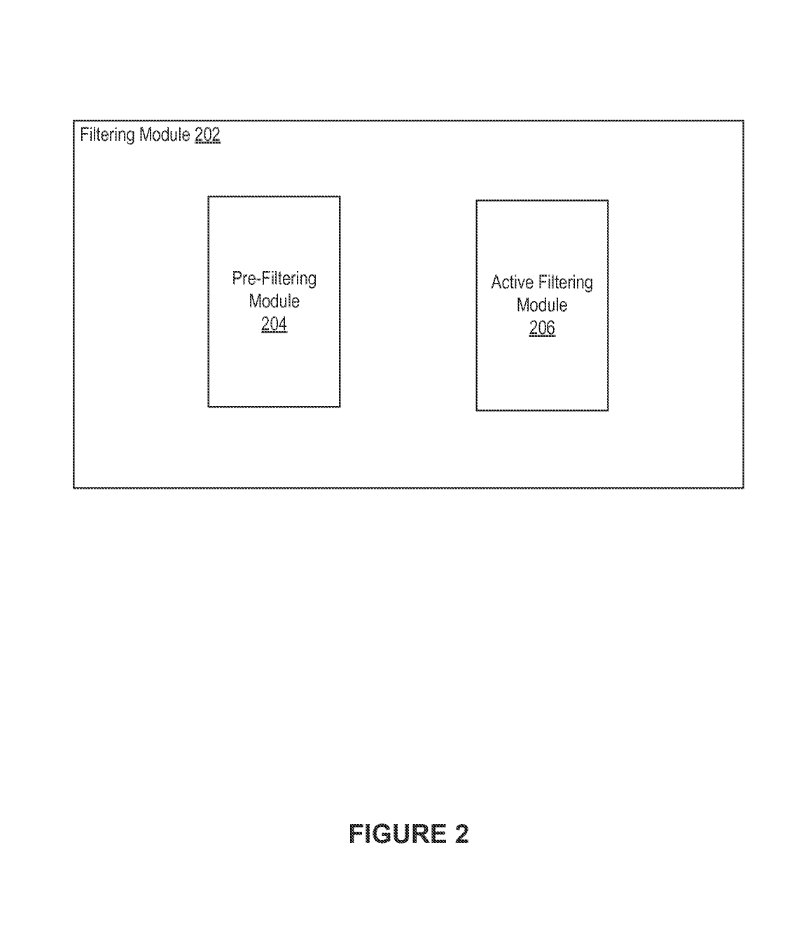

FIG. 2 illustrates an example filtering module 202 configured to filter content posts and/or multimedia content items posted to a social networking system based on filtering criteria, according to an embodiment of the present disclosure. As discussed in greater detail below, the filtering criteria can include both pre-filtering criteria and active filtering criteria. In some embodiments, the filtering module 104 of FIG. 1 can be implemented as the example filtering module 202. As shown in FIG. 2, the filtering module 202 can include a pre-filtering module 204 and an active filtering module 206.

The pre-filtering module 204 can be configured to filter out various content posts and/or multimedia content items based on various pre-filtering criteria. Content posts and/or multimedia content items on the social networking system can be filtered to determine which content posts and/or multimedia content items to utilize in a multimedia replay feed. For example, the pre-filtering module 204 can be configured to filter out any content posts that do not contain any multimedia content items, such as text status messages or notes. The pre-filtering module 204 can also filter content posts that a user has previously seen. The pre-filtering module 204 can also be configured to filter out content posts that were posted earlier than a time threshold. For example, the pre-filtering module 204 can filter out any content posts that were posted prior to the time of the user's last login onto a social networking system. In other words, the pre-filtering module 204 can be configured to include only “new” content posts that the user has not seen since his or her last login. In other embodiments, the time threshold may be a predefined period of time, such that the pre-filtering module 204 filters out all content posts that are, for example, more than one day or one week old. In certain embodiments, users may be presented with a list of users who have posted “new” content, and the user can select which users' content the user wishes to include in the current multimedia replay feed.

The active filtering module 206 can be configured to filter out various content posts and/or multimedia content based on user-defined active-filtering criteria. In certain embodiments, a user can define active-filtering criteria by selecting particular persons or things that the user wishes to remove from his or her future multimedia replay feeds. For example, a user can select a person (e.g., an ex-significant other) so that multimedia content items posted by the selected person or involving the selected person, such as a photo in which the selected person is tagged, will not be included in the user's multimedia replay feed. Multimedia content items can be indexed or tagged so that when a user is presented with a particular multimedia content item, the user can select various people and/or things that are depicted in the multimedia content item to include them in the user's active filter. Tagging may be automatically performed, for example, using image recognition techniques, or can be based on user-created tags. When a user selects a particular person or thing to be included in his or her “active filter,” future multimedia replay feeds may be filtered to remove any multimedia content items involving the selected persons or things, and the current multimedia replay feed can also be amended to remove any such multimedia content items. Users may be given the option to remove persons or things that were previously added to their active filter, or to turn active filtering on or off.

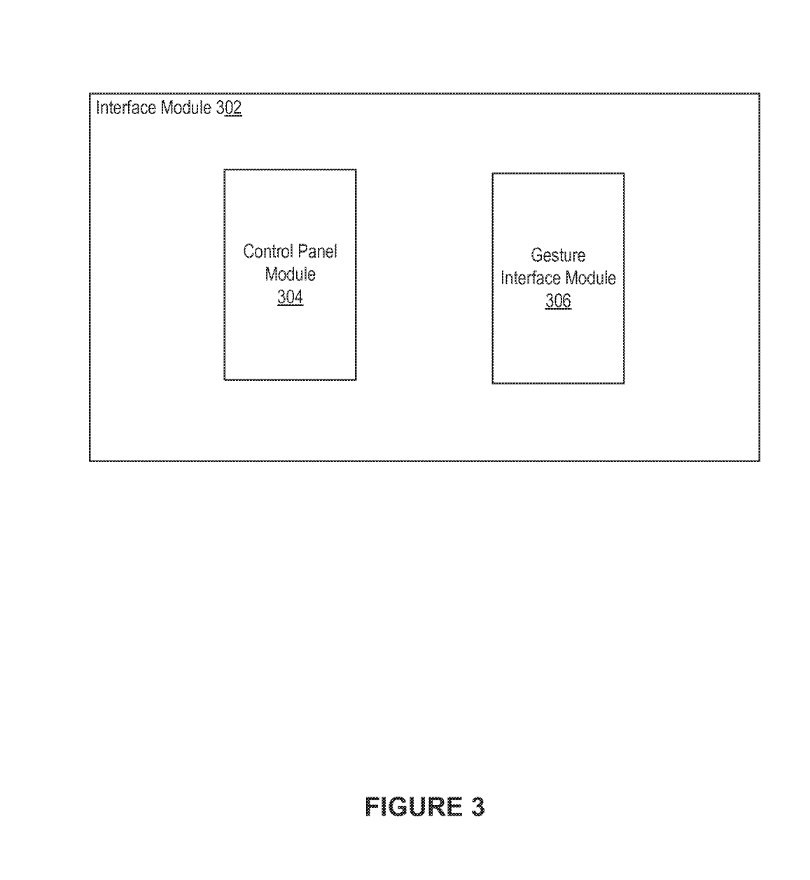

FIG. 3 illustrates an example interface module 302 configured to provide a user interface for presenting and interacting with a multimedia replay feed, according to an embodiment of the present disclosure. In some embodiments, the interface module 108 of FIG. 1 can be implemented as the example interface module 302. As shown in FIG. 3, the interface module 302 can include a control panel module 304 and a gesture interface module 306.

The control panel module 304 can be configured to allow a user to interact with a multimedia replay feed via a control panel. In certain embodiments, the control panel can include buttons that allow a user to play a multimedia replay feed, pause a multimedia replay feed, adjust the playback speed of a multimedia replay feed, rewind a multimedia replay feed, and skip ahead in a multimedia replay feed. A user's playback speed preference may be saved such that when a user adjusts a playback speed, or defines a default playback speed, the user's playback speed preference can be applied to all future multimedia replay feeds for that user.

The control panel module 304 can also be configured to allow a user to interact with a particular multimedia content item presented in the multimedia replay feed. For example, the control panel module 304 can include a button for a user to “like” a multimedia content item, a separate button for a user to comment on the multimedia content item, and another button for a user to tag people in a multimedia content item. In certain embodiments, when a user interacts with a particular multimedia content item, the multimedia replay feed can automatically pause to allow the user time to complete interaction with the multimedia content item. For example, if a user wishes to comment on a particular photograph in the multimedia replay feed, the user can select a comment button, which can pause the multimedia replay feed, and allow the user to comment on the photograph. In certain embodiments, a user can select the “like” button to like a particular multimedia content item without pausing or disrupting the multimedia replay feed. If the user selects the “common” or “tag” button for a particular multimedia content item, the multimedia replay feed can be paused, and the particular multimedia content item can be opened up to allow the user to comment or tag. When the particular multimedia content item is opened up, any associated text content items or other associated text content items that were not displayed in the multimedia replay feed may be displayed. When the user completes interaction with the particular multimedia content item, the multimedia replay feed can resume.

The gesture interface module 306 can be configured to allow a user to interact with a multimedia replay feed via gestures. In certain embodiments, the gesture interface module 306 can be configured to allow a use to interact with a multimedia replay feed in similar ways to the control panel module 304, but via gestures rather than a control panel. For example, a user can pause or play the multimedia replay feed by tapping the multimedia replay feed. A user can adjust the playback speed of the multimedia replay feed by swiping in a particular direction. For example, swiping from left to right, or bottom to top, can speed up playback, and swiping from right to left, or top to bottom, can slow down playback. In another example of a gesture control, a user can manually swipe between multimedia content items by pausing the multimedia replay feed, and swiping in a particular direction, e.g., swiping left to move to the next multimedia content item and swiping right to move to the previous multimedia content item. The gesture interface module 306 and the control panel module 304 can be utilized in tandem to allow a user to choose the easiest way to control the multimedia replay feed.

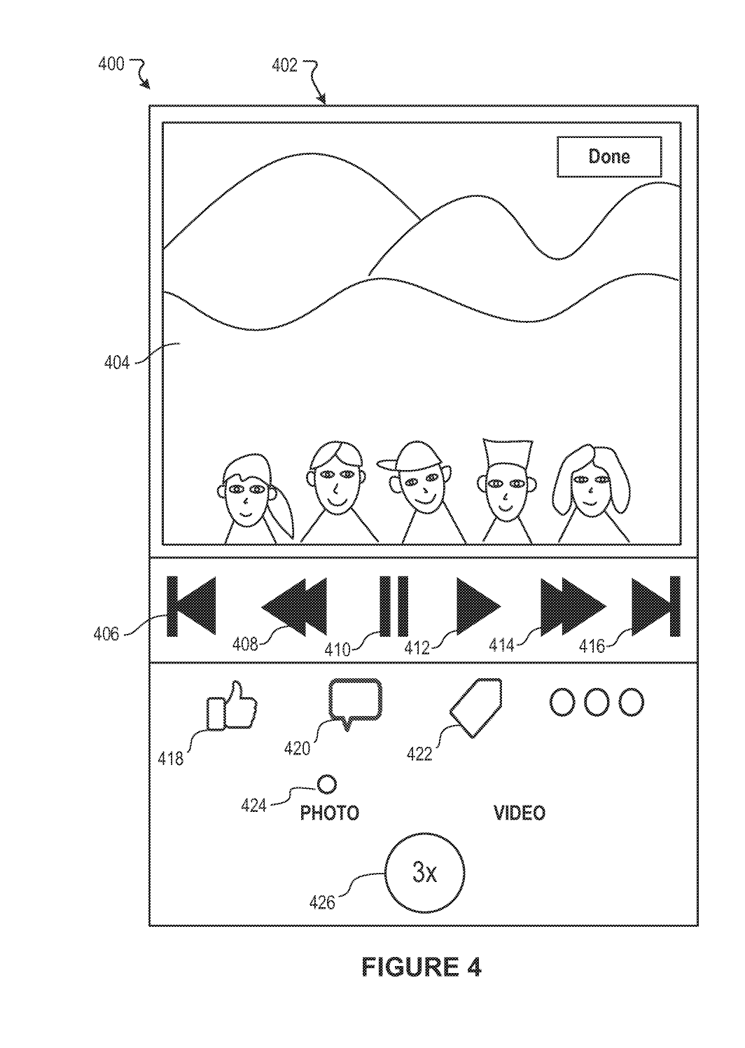

FIG. 4 illustrates an example scenario 400 associated with presenting and interacting with a multimedia replay feed, according to an embodiment of the present disclosure. The example scenario 400 illustrates an example interface 402 for presenting and interacting with a multimedia replay feed. In certain embodiments a user may be presented with a news feed when the user logs into a social networking system. The user may be presented with an option to begin playing a multimedia replay feed, for example, by selecting a “Replay” button somewhere on or near the news feed. Selecting the Reply button can open up the example interface 402 and begin playing the multimedia replay feed, comprising successive presentation of one or more new multimedia content items without user intervention to advance the presentation. As shown in FIG. 4, the example interface 402 includes a display area 404 for presenting a multimedia replay feed (in this case, a photograph), and various buttons for interacting with the multimedia replay feed. As can be seen in FIG. 4, a user can pause the multimedia replay feed (button 410), play the multimedia replay feed (button 412), speed up or fast forward (button 414), slow down or rewind (button 408), skip backward (button 406) or skip forward (button 416).

A user can also like a particular multimedia content item currently being displayed in the multimedia replay feed via a button 418, comment on the particular multimedia content item via a button 420, and tag a particular multimedia content item via a button 422. A multimedia type indicator 424 can provide an indication of the type of multimedia content item currently being shown in the multimedia replay feed. In FIG. 4, the multimedia type indicator 424 is positioned above the word “PHOTO,” indicating that a photograph is currently being displayed, and can move between “PHOTO” and “VIDEO” based on the type of multimedia content item being displayed in the multimedia replay feed. A playback speed indicator 426 can provide an indication of the current playback speed. In FIG. 4, a user has sped up playback from a default setting (1×) such that the playback is now playing 3-times faster (3×). In certain embodiments, a default playback speed may be implemented such that a multimedia content item is presented for a default playback time before moving to the next multimedia content item. The default playback time may differ based on the type of multimedia content item. For example, the default playback time may be one second for photographs, a three seconds for videos, such that, on a default playback setting, each photograph will be shown for one second, and each video will be played for three seconds before moving to the next multimedia content item. In certain embodiments, a user can adjust default playback times, and can adjust playback speed by up to ten times (10×) faster or ten times (10×) slower than the default playback speed.

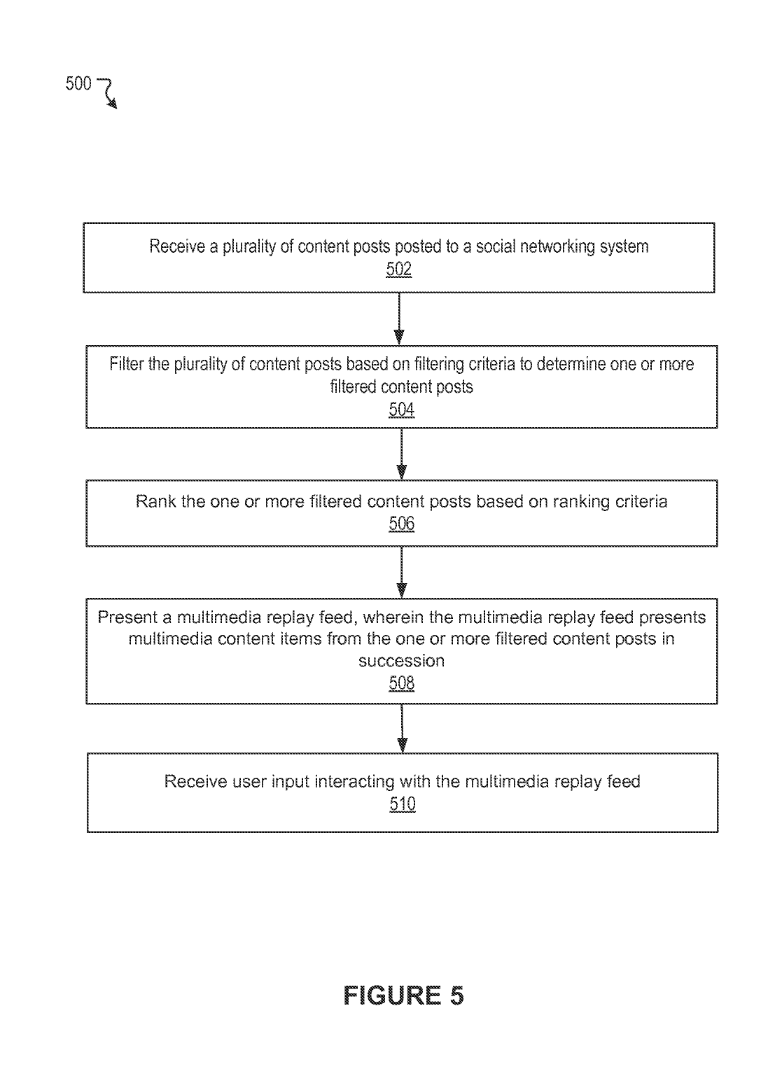

FIG. 5 illustrates an example method 500 associated with providing multimedia replay feeds, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can receive a plurality of content posts posted to a social networking system. At block 504, the examiner method 500 can filter the plurality of content posts based on filtering criteria to determine one or more filtered content posts. At block 506, the example method 500 can rank the one or more filtered content posts based on ranking criteria. At block 508, the example method 500 can present a multimedia replay feed, wherein the multimedia replay feed presents multimedia content items from the one or more filtered content posts in succession. At block 510, the example method 500 can receive user input interacting with the multimedia replay feed.

### Social Networking System—Example Implementation

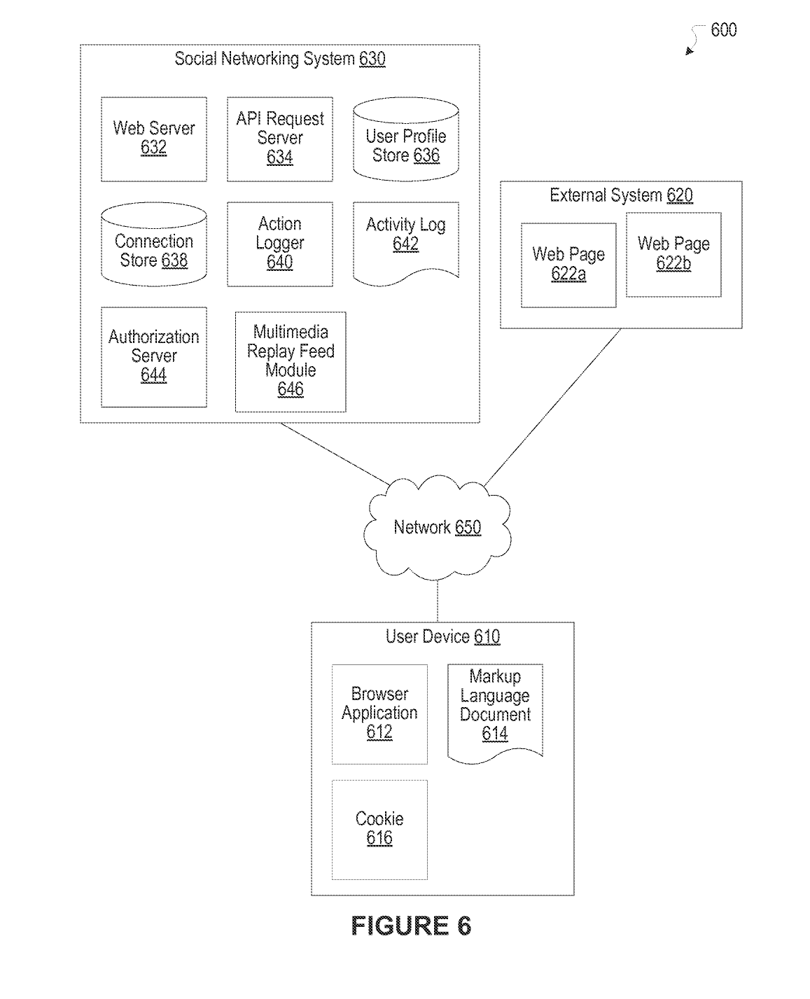

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an multimedia replay feed module 646. The multimedia replay feed module 646 can, for example, be implemented as the multimedia replay feed module 102, as discussed in more detail herein. As discussed previously, it should be appreciated that there can be many variations or other possibilities. For example, in some embodiments, one or more functionalities of the multimedia replay feed module 646 can be implemented in the user device 610.

### Hardware Implementation

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a plurality of content posts posted to a social networking system;
filtering, by the computing system, the plurality of content posts based on filtering criteria to determine one or more filtered content posts; and
presenting, by the computing system, multimedia content items from the one or more filtered content posts in succession as a multimedia feed, wherein succession of the multimedia content items occurs without user intervention.

2. The computer-implemented method of claim 1, further comprising ranking the one or more filtered content posts based on ranking criteria.

3. The computer-implemented method of claim 2, wherein the presenting the multimedia content items comprises presenting multimedia content items from the one or more filtered content posts in succession in an order based on the ranking the one or more filtered content posts.

4. The computer-implemented method of claim 3, wherein the one or more filtered content posts are ranked chronologically.

5. The computer-implemented method of claim 1, wherein the presenting the multimedia content items comprises presenting multimedia content items from the one or more filtered content posts in succession without any text content items.

6. The computer-implemented method of claim 1, wherein the filtering the plurality of content posts based on filtering criteria comprises filtering the plurality of content posts to remove content posts that do not contain multimedia content items.

7. The computer-implemented method of claim 1, wherein the filtering the plurality of content posts based on filtering criteria comprises filtering the plurality of content posts to remove content posts that have previously been viewed by a user.

8. The computer-implemented method of claim 1, wherein the filtering the plurality of content posts based on filtering criteria comprises filtering the plurality of content posts to remove content posts that do not satisfy a time threshold.

9. The computer-implemented method of claim 8, wherein the time threshold is based on a last login time for a user.

10. The computer-implemented method of claim 1, wherein the filtering the plurality of content posts based on filtering criteria comprises receiving active filtering criteria from a user.

11. A system comprising:
at least one processor; and
a memory storing instructions that, when executed by the at least one processor, cause the system to perform a method comprising:
receiving a plurality of content posts posted to a social networking system;
filtering the plurality of content posts based on filtering criteria to determine one or more filtered content posts; and
presenting multimedia content items from the one or more filtered content posts in succession as a multimedia feed, wherein succession of the multimedia content items occurs without user intervention.

12. The system of claim 11, wherein the method further comprises ranking the one or more filtered content posts based on ranking criteria.

13. The system of claim 12, wherein the presenting the multimedia content items comprises presenting multimedia content items from the one or more filtered content posts in succession in an order based on the ranking the one or more filtered content posts.

14. The system of claim 13, wherein the one or more filtered content posts are ranked chronologically.

15. The system of claim 11, wherein the presenting the multimedia content items comprises presenting multimedia content items from the one or more filtered content posts in succession without any text content items.

16. A non-transitory computer-readable storage medium including instructions that, when executed by at least one processor of a computing system, cause the computing system to perform a method comprising:
receiving a plurality of content posts posted to a social networking system;
filtering the plurality of content posts based on filtering criteria to determine one or more filtered content posts; and
presenting multimedia content items from the one or more filtered content posts in succession as a multimedia feed, wherein succession of the multimedia content items occurs without user intervention.

17. The non-transitory computer-readable storage medium of claim 16, wherein the method further comprises ranking the one or more filtered content posts based on ranking criteria.

18. The non-transitory computer-readable storage medium of claim 17, wherein the presenting the multimedia content items comprises presenting multimedia content items from the one or more filtered content posts in succession in an order based on the ranking the one or more filtered content posts.

19. The non-transitory computer-readable storage medium of claim 18, wherein the one or more filtered content posts are ranked chronologically.

20. The non-transitory computer-readable storage medium of claim 16, wherein the presenting the multimedia content items comprises presenting multimedia content items from the one or more filtered content posts in succession without any text content items.
